(19) United States
(12) Patent Application Publication
(10) Pub. No.: US 2014/0378563 A1
(43) Pub. Date: Dec. 25, 2014

(54) SOLID STATE VAPOR PHASE POLYMERIZATION METHOD FOR NANOPOROUS POLYPYRROLE AND NANOPOROUS POLYPYRROLE PREPARED THEREFROM

(71) Applicant: GWANGJU INSTITUTE OF SCIENCE AND TECHNOLOGY, Gwangju (KR)

(72) Inventors: Kurt E. GECKELER, Gwangju (KR); Attia NOUR FATHI, Gwangju (KR)

(73) Assignee: GWANGJU INSTITUTE OF SCIENCE AND TECHNOLOGY, Gwangju (KR)

(21) Appl. No.: 14/141,286

(22) Filed: Dec. 26, 2013

(30) Foreign Application Priority Data
Jun. 24, 2013 (KR) 10-2013-0072186

(51) Int. Cl. C08G 73/06; C08J 9/00

(52) U.S. Cl. CPC C08G 73/0611; C08J 9/00
USPC 521/50

(57) ABSTRACT

Disclosed herein is a method for preparing a nanoporous polypyrrole for storing gas such as hydrogen, carbon dioxide, or the like, and a nanoporous polypyrrole prepared therefrom. More particularly, disclosed herein are a solid state vapor phase polymerization method for nanoporous polypyrrole, the method comprising dispersing a solid state oxidant on a substrate; exposing the substrate and the oxidant to vapor phase pyrrole monomers to perform a polymerization reaction of the pyrrole monomers to thereby prepare a solid state polypyrrole; and cleaning and drying the solid state polypyrrole; and a nanoporous polypyrrole prepared therefrom.

### CROSS REFERENCE TO RELATED APPLICATION

This application claims priority to Korean Patent Application No. 10-2013-0072186 on 24 June, 2013, and all the benefits accruing therefrom under 35 U.S.C. §119, the contents of which is incorporated by reference in its entirety.

### BACKGROUND OF THE INVENTION

1. Technical Field

The present invention relates to a method for preparing a nanoporous polypyrrole for storing gas such as hydrogen or carbon dioxide, and a nanoporous polypyrrole prepared therefrom.

2. Description of the Related Art

Recently, renewable energy sources such as hydrogen are attracting more and more attention. In particular, hydrogen has a much higher energy density (142 MJ/kg) than other hydrocarbon fuels, and is therefore known to play an important role in solving the problems relating to energy depletion. The U.S. Department of Energy has established various criteria for vehicles regarding reversible hydrogen storage according to gravimetric and volumetric measurements. This has urged researchers to study diverse materials for hydrogen storage.

Conductive polymers having various nanostructures exhibit the properties of an organic conductor and low volume system, have interesting physicochemical properties, and are very useful for various applications. Polypyrrole is one of the well-known conductive polymers under research, which exhibits excellent thermal and environmental stabilities, as well as good electric conductivity essentially required in various applications.

There is a report that commercial polyaniline and polypyrrole may store hydrogen of 6 to 8 wt % (“Fuel Chemistry Division Preprints” 2002, 47(2), 790-791 by S. J. Cho, K. S. Song, J. W. Kim, T. H. Kim, and K. Choo), but other researchers failed to realize such results (“Synthetic Metals” 2005, 151:208-210 by B. Panella, L. Kossykh, U. Dettlaff-Weglikowsa, M. Hirscher, G. Zerbi, S. Roth). Further, there exist contradictory researches on the hydrogen storage capacities of polymer nanostructures and the composites thereof (“Catalysis Today” 2007, 120:336-340 by S. J. Cho, K. Choo, D. P. Kim, and J. W. Kim; “Journal of Materials Chemistry” 2007, 17:4989-4997 by J. Germain, J. M. J. Frechet, F. Svec; “International Journal of Hydrogen Energy” 2007, 32:1010-1015 by M. U. Jurczyk, A. Kumar, S. S. Srinivasan, E. K. Stefanakos; “Macromolecular Rapid Communications” 2007, 28: 995-1002 by N. B. McKeown, P. M. Budd, D. Book; “International Journal of Hydrogen Energy” 2010, 35:225-230 by S. S. Srinivasan, R. Ratnadurai, M. U. Niemann, A. R. Phani, D. Y. Goswami, E. K. Stefanakos).

From the above, it is concluded that there exist many factors involved in the process that hydrogen are adsorbed on solid materials, which include the effects of surface texture on hydrogen absorption. Accordingly, solid state hydrogen storage materials would be commercially available only after these factors are generally considered (“International Journal of Hydrogen Energy” 2010, 35:225-230 by S. S. Srinivasan, R. Ratnadurai, M. U. Niemann, A. R. Phani, D. Y. Goswami, E. K. Stefanakos).

In the related art, a vapor-phase polymerization method comprising applying a solution state oxidant to various templates or substrates to polymerize pyrrole has been proposed (“Synthetic Metals” 1986, 14:189-197 by A. Mohammadi, M. A. Hasan, B. Liedberg, I. Lundstrom, W. R. Salaneck). In this method, coating the oxidant on the substrate, followed by exposing to pyrrole vapor was carried out. The above liquid state vapor phase polymerization method has been used in forming conductive polypyrrole thin films on non-woven fibers and textile fabrics, as well as various substrates. In all of the cases mentioned above, the templates, substrates, fibers or textile fabrics should be dipped into a solution containing oxidants and dopants, prior to the exposure to pyrrole vapor.

However, since the conventional method which uses a liquid oxidant or a dopant requires a separate solvent for preparing an oxidant solution or a dopant solution, and needs to conduct a process of dipping a substrate into the oxidant solution or the dopant solution prepared using the solvent, the method may cause process complexity and environmental contamination problems. Further, since such prepared polypyrrole does not contain porous structures on the surface or inside thereof, the adsorption capacity to gases such as hydrogen or carbon dioxide is not good, which is unsuitable for use as a material for gas storage.

### SUMMARY OF THE INVENTION

An object of the present invention is to provide a solid state vapor phase polymerization method for nanoporous polypyrrole, and the nanoporous polypyrrole prepared therefrom, which is simple and environment-friendly since a liquid oxidant or a dopant solution is not used therein, and which can provide a polypyrrole having mesopore structures on the surface and inside thereof and therefore exhibit an excellent adsorption capacity to gases such as hydrogen or carbon dioxide suitable for use as a material for gas storage.

According to an exemplary embodiment of the present invention, there is provided a solid state vapor phase polymerization method for nanoporous polypyrrole, including: dispersing a solid state oxidant on a substrate; exposing the substrate and the oxidant to vapor phase pyrrole monomers to perform a polymerization reaction of the pyrrole monomers, thereby preparing a solid state polypyrrole; and cleaning and drying the solid state polypyrrole.

The exposure to the vapor phase pyrrole monomers may be carried out for 2 to 48 hours.

The exposure to the vapor phase pyrrole monomers may include introducing a solution of liquid state pyrrole monomers into a sealed container, and evaporating the solution therefrom.

The oxidant may include ferric chloride (FeCl₃) powder, ammonium persulfate ((NH₄)₂S₂O₈) powder, ferric sulfate (Fe₂(SO₄)₃) powder, copper perchlorate (Cu(ClO₄)₂) powder, or a mixture thereof.

The cleaning may include primarily cleaning the solid state polypyrrole with deionized water and secondarily cleaning the solid state polypyrrole with methyl alcohol.

The drying may be carried out at a temperature of 50 to 160 under vacuum.

According to another exemplary embodiment of the present invention, there is provided a nanoporous polypyrrole prepared by any one of the methods described above.

The nanoporous polypyrrole may have a sponge-like structure where mesopores having a diameter of 1.75 nm to 9.5 nm are formed on the surface and inside thereof.

The nanoporous polypyrrole, at the temperature of 77 K under a pressure of 8 MPa to 9 MPa, may be capable of adsorb 0.70 wt % to 2.5 wt % of hydrogen gas thereon with reference to the weight of the nanoporous polypyrrole.

### BRIEF DESCRIPTION OF THE DRAWINGS

FIG. 1 is a schematic view which shows processes of preparing a nanoporous polypyrrole using a solid state vapor phase polymerization, and then adsorbing hydrogen gas.

FIG. 2 shows an FTIR spectrum of a nanoporous polypyrrole prepared at various reaction times in accordance with an exemplary embodiment of the present invention.

FIGS. 3A through 3G show SEM images for nanoporous polypyrrole and commercial polypyrrole thin films prepared under conditions of 2 hours of reaction time (FIG. 3A), 2 hours reaction time under the application of high magnetic field (FIG. 3B), 6 hours of reaction time (FIG. 3C), 6 hours of reaction time under the application of high magnetic field (FIG. 3D), 24 hours of reaction time (FIG. 3E), and 48 hours of reaction time (FIG. 3F), respectively.

### DESCRIPTION OF THE EXEMPLARY EMBODIMENTS

Exemplary embodiments of the present invention will now be described in detail with reference to the accompanying drawings.

The present invention provides a method of capable of preparing a nanoporous polypyrrole with excellent gas storage capacity at ambient temperature under atmospheric pressure by means of a simple and environment-friendly process without using separate solvents for making oxidant solutions and the like. Further, the prepared nanoporous polypyrrole has a unique form of sponge-like structure where mesopores are formed thereon and therein, which exhibits an excellent adsorbing capacity for gases such as hydrogen and carbon dioxide.

In particular, a method for preparing a nanoporous polypyrrole comprises: dispersing a solid state oxidant on a substrate; exposing the substrate and the oxidant to vapor phase pyrrole monomers to perform a polymerization reaction of the pyrrole monomers to thereby prepare a solid state polypyrrole; and cleaning and drying the solid state polypyrrole.

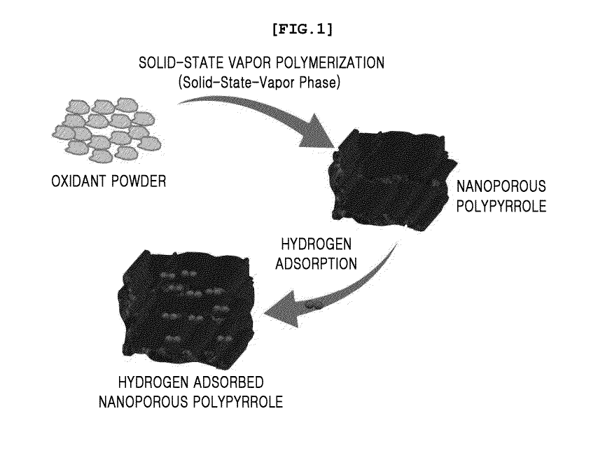

FIG. 1 schematically shows a process of preparing a nanoporous polypyrrole using a solid state vapor phase polymerization, and then adsorbing hydrogen gas thereon. Referring to FIG. 1, the polymerization is carried out by exposing vapor phase pyrrole monomers to a solid state oxidant powder, thereby a solid state polypyrrole can be formed. Examples of the oxidant include ferric chloride (FeCl₃) powder, ammonium persulfate ((NH₄)₂S₂O₈) powder, ferric sulfate (Fe₂(SO₄)₃) powder, copper perchlorate (Cu(ClO₄)₂) powder, or mixtures thereof. The synthesis of polypyrrole by an oxidation reaction of the pyrrole monomers may be represented by the following Chemical formula 1:

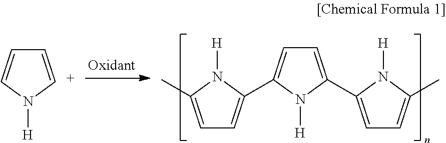

This polymerization reaction (1) may be carried out by a simple process at ambient temperature under atmospheric pressure, for example by introducing a solution of liquid phase pyrrole monomers into a sealed container, and polymerizing the pyrrole monomers evaporated from the solution by oxidant powders in the sealed container

In this case, as will be further described in the examples below, the exposure time at which the oxidant powders are exposed to the vapor phase pyrrole monomers, i.e., vapor phase polymerization reaction time, has a significantly greater effect on the structure of resultant nanoporous polyryrrole, and thereby also greater effect on the gas adsorption capacity. In particular, in the present invention, the exposure time of the oxidant powder to the vapor phase pyrrole monomers may be from 2 to 48 hours.

If the exposure time is less than 2 hours, a sufficient time for the polymerization of the pyrrole monomers cannot be acquired, and therefore the nanoporous polypyrrole cannot be easily produced. If the exposure time is more than 2 hours, an excess amount of oxidant is consumed, and therefore a sponge-like morphology in the resultant product may be reduced. The cause for this may be found in a production mechanism of the nanoporous structure. That is, the porous sponge-like structure consisting of surface mesopores, and inner pores and pockets according to the present invention may be obtained in the nanoporous polypyrrole, because the solid oxide particles which do not participate in the reaction and are covered with polypyrrole chains deposited thereon during the reaction to be unreacted leave behind in the resultant polypyrrole, and, subsequently, if these solid oxide particles are melted during cleaning, the surface mesopores, and the inner pores and pockets are formed there.

Therefore, if the exposure time, i.e., the time required in the vapor phase polymerization reaction takes too long, excess amounts of solid oxidant particles are consumed in the reaction, and therefore the amount of the solid oxide particles remaining in the resultant polypyrrole becomes lower, which results in a reduced number of mesopores thus produced. In this regard, as further can be seen from the data of the examples below, the volumes of mesopores in the samples become smaller as the reaction time increases to 6 hours, 24 hours and 48 hours, compared to 2 hours. The reaction time at which the nanoporous polypyrrole prepared by the present invention can provide suitable properties for use as an adsorbing material for gases such as hydrogen or carbon dioxide should be up to 48 hours.

In the method for preparing a mesoporous polypyrrole in accordance with the present invention, after preparing the solid state polypyrrole by the vapor phase polymerization reaction, the resulting solid state polypyrrole may be washed and dried. The cleaning may be carried out by primarily cleaning the solid state polypyrrole with deionized water and secondarily cleaning the solid state polypyrrole with methyl alcohol, thereby the unreacted oxidant particles remaining in the solid state polypyrrole can be removed.

The drying may be carried out at a temperature range of 50 to 160 under vacuum. When the drying temperature is less than 50° C. sufficient drying cannot be achieved. When the drying temperature exceeds 160° C. the loss of dopants becomes large.

Further, provided herein is a nanoporous polypyrrole prepared by the afore-mentioned method.

As described earlier, a nanoporous polypyrrole prepared in accordance with the present invention provides an excellent gas adsorbing capacity, and is therefore useful for use as a material for gas storage. In particular, since the nanoporous polypyrrole may have a sponge-like structure where mesopores with diameter of 1.75 nm to 9.5 nm are formed on the surface and inside thereof, gases such as hydrogen and carbon dioxide can be adsorbed onto such sponge-like structure.

For example, when hydrogen gas is adsorbed to the nanoporous polypyrrole at the temperature of 77 K under a pressure of 8 MPa to 9 MPa, the nanoporous polypyrrole may adsorb 0.70 wt % to 2.5 wt % of hydrogen gas, based on the weight of the nanoporous polypyrrole, which is comparable with other commercial nanoporous polymers having high surface area.

Hereinafter, exemplary embodiments of the present invention will now be described in more detail by means of examples only, but should not be construed to limit the scope of the present invention.

### EXAMPLE

### The Preparation of Nanoporous Polypyrrole

500 mg of ferric chloride in the form of solid powder was dispersed on glass substrate. Then, the substrate was subjected to exposure to pyrrole vapor, which was carried out by introducing 10 mL solution of liquid pyrrole monomers into a sealed beaker, and evaporating the solution at ambient temperature under atmospheric pressure to generate pyrrole vapor. The exposure time to pyrrole vapor was varied as 2, 6, 24 and 48 hours, respectively. The polymerized polypyrrole samples were removed from the glass substrate, and the resulting products were washed several times via centrifugal separation with deionized water (1200 rpm, 10 min), and subsequently washed 5 times via centrifugal separation with 10 mL of methyl alcohol under the same conditions (1200 rpm, 10 min). Finally, the samples were dried at 60 under vacuum. The resulting samples (final yield: 120 mg) were referred to as PPYₛᵥₚX, where X denotes to reaction time, for example, 2, 6, 24, or 48 hours.

### Evaluation Example

FIG. 1 is a schematic view which shows a process of preparing a nanoporous polypyrrole in accordance with one exemplary embodiment of the present invention. Inner structure of the prepared material was identified through spectroscopy and textural properties of the pores. The resulting nanoporous polymer was insoluble, and therefore had limited structural properties. However, the properties of the prepared nanoporous polypyrrole were identified by FTIR spectroscopy, SEM and electric conductivity measurements.

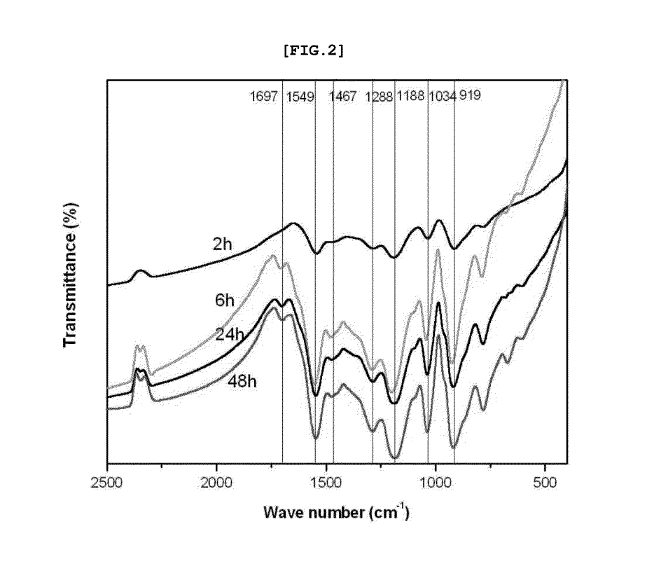

FIG. 2 shows FTIR absorption peaks of nanoporous polypyrroles prepared at various reaction times. The absorption band at 1549 cm⁻¹ was caused by pyrrole ring, which shows a combination of C—C and C═C stretching vibrations, and the absorption band at 1467 cm⁻¹ was caused by C—N stretching vibration. The absorption band at 1034 cm⁻¹ corresponds to C—H and N—H in-plane deformation vibrations, and the absorption band at 1288 cm⁻¹ corresponds to C—H and C—N in-plane deformation vibrations. The absorption band at 919 cm⁻¹ corresponds to C═C in-plane bending vibration in pyrrole ring, which demonstrates the generation of a doped nanoporous polypyrrole, and the band at 1188 cm⁻¹ corresponds to C—N stretching vibration, which verifies a doped polypyrrole. The absorption peak at 777 cm⁻¹ relates to C—H out-of-plane bending vibration. The weak absorption band at 1697 cm⁻¹ corresponds to a C═O stretching vibration in the nanoporous polypyrrole prepared during the reaction time of 6 to 48 hours, from which there were found some of the pyrrole rings in the polypyrrole peroxidized, with the reaction time increasing.

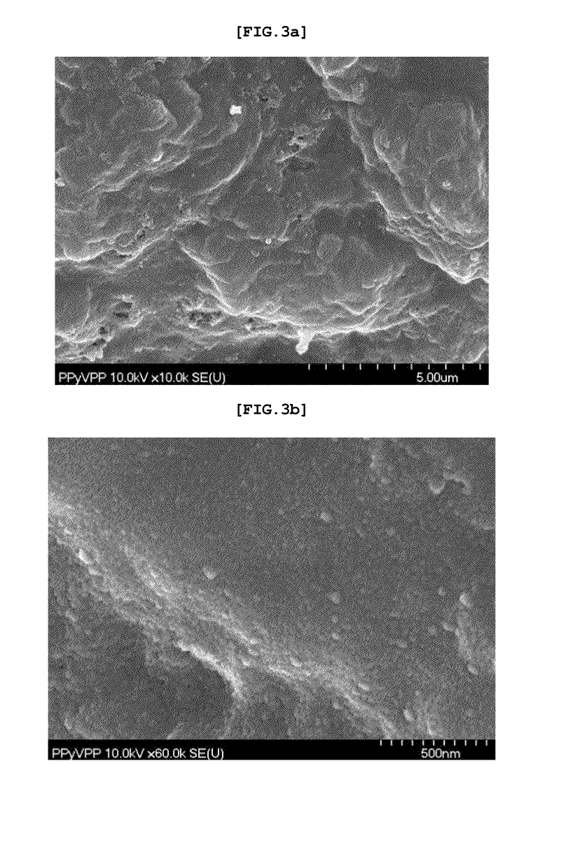

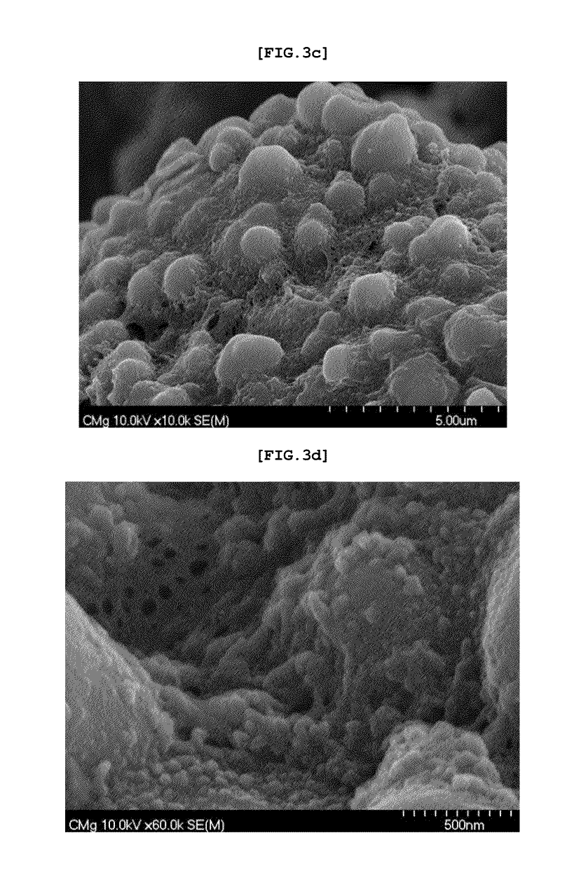

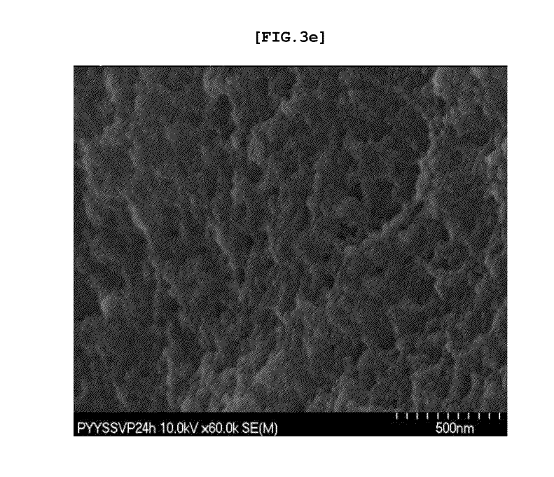

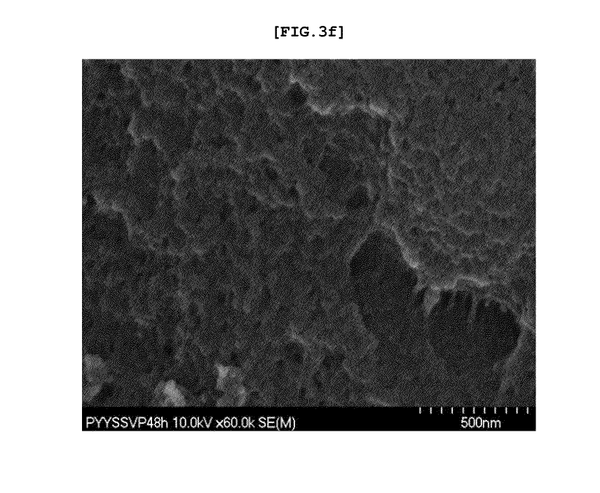

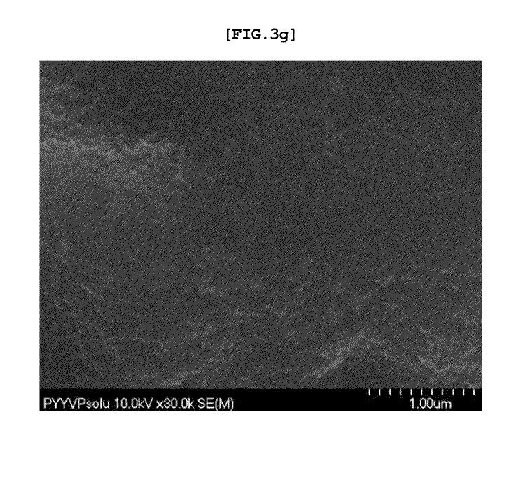

FIG. 3 shows SEM images of the morphology of prepared PPYₛᵥₚ. As can be seen from FIGS. 3A through 3F, the pores are found on the surface of the prepared PPYₛᵥₚ samples, which indicates that sponge-like PPYₛᵥₚ was produced by the exemplary embodiments of the present invention. As can be seen from the images of the samples reacted during 2 hours and 6 hours, the inner pores and pockets are interconnected with the outer nanopores, which indicates the generation of mesoporous structure. The materials prepared according to the exemplary embodiments of the present invention exhibit significantly excellent hydrogen adsorption capacities, which is viewed as caused by the sponge-like structure observed from FIG. 3.

Meanwhile, with the reaction time increasing, the solid oxidant powders were also consumed increasingly, and the sponge-like structures were less produced (see FIGS. 3E and 3F). Comparison of the case where reactions occurred during 24 hours and 48 hours with the case where reactions occurred during 2 hours and 6 hours indicates that, when the reaction time increased, the pore volume and the diameter were decreased. The adsorbing capacities of PPYₛᵥₚ2h for hydrogen and carbon dioxide were observed, from which there were found that PPYₛᵥₚ2h had an excellent reversible carbon dioxide adsorbing capacity.

FIG. 3 shows a surface roughness in the morphology of PPYₛᵥₚ surface structure, which indicates a significantly different aspect compared with those prepared by the conventional vapor phase polymerization method (see FIG. 3G). In the case of the conventional vapor phase polymerization method, since polypyrrole thin films were formed by drop-casting a solution of iron oxide oxidant in a solvent such as methanol on the glass substrate, and exposing the substrate to pyrrole vapor, no porous structures were observed. Therefore, the generation of porous structures can be facilitated in the polypyrrole formed using a solid state oxidant as in the embodiments of the present invention. Further, the electric conductivity of PPYₛᵥₚ2h measured by 4-point probe was 1.24 S/cm.

The surface properties of PPYₛᵥₚ were determined by BET method and specific surface area analysis. The nitrogen adsorption-desorption isothermal curves of PPYₛᵥₚ prepared at various reaction time were found to have a combined shape of type II and type IV. Bigger hysteresis loops were observed under relatively high pressures, which indicates that the pore diameters in mesoporous materials were in the range of 2 nm to 50 nm. The mesopore diameters of the respective PPYₛᵥₚ samples were calculated using BET method. Texture properties such as BET surface area, total pore volume, mesopore volume, and average mesopore diameter for PPYₛᵥₚ samples are summarized in Table 1 below.

TABLE 1

| Samples at | | | | | |
|---|---|---|---|---|---|
| various | | | | | H₂ adsorbing |
| reaction | S_{BET}^{a)} | Vₜₒₜ^{b)} | Vₘₑₛₒ^{c)} | D_{BJH}^{d)} | capacity^{e)} |
| times | [m²/g] | [cm³/g] | [cm³/g] | [nm] | [wt %] |
| PPYₛᵥₚ2 h | 51.34 | 0.34 | 0.32 | 7.82 | 2.2 |
| PPYₛᵥₚ6 h | 40.31 | 0.30 | 0.28 | 6.25 | 1.9 |
| PPYₛᵥₚ24 h | 40.36 | 0.27 | 0.25 | 5.42 | 1.44 |
| PPYₛᵥₚ48 h | 40.99 | 0.25 | 0.23 | 5.39 | 0.71 |

^{a)}BET surface area.
^{b)}Total pore volume at P/P₀ = 0.99
^{c)}Mesopore volume calculated by Vₜₒₜ − V_{micro}.
^{d)}Average mesopore diameter calculated based on BJH method from adsorption-desorption curves of N2 isothermal lines.
^{e)}Hydrogen storage capacity for 2 h sample was determined at 77 K and 9 MPa, and hydrogen storage capacity for other samples was determined at 77 K and 8 MPa.

As can be seen from Table 1 above, the total pore volume of PPYₛᵥₚ2h was 0.34 cm³/g, and the mesopore volume was 0.32 cm³/g. The mesopore volume was decreased as the reaction time increased, and for example PPYₛᵥₚ6h was 0.28 cm³/g, PPYₛᵥₚ24h was 0.25 cm³/g, and PPYₛᵥₚ48h was 0.23 cm³/g. Such results were matched with the decreases of the sponge-like morphology observed in FIG. 3, which relates to the production mechanism of nanoporous structures according the embodiments of the present invention, indicating that the unreacted solid oxidant particles were melted to thereby form the inner pores and pockets. That is, as the reaction time increases, more oxidants are consumed, and therefore the pore volume and the sponge-like morphology were reduced in the resultant products. This coincides with the actual observation results that when BJH pore diameter for PPYₛᵥₚ2h was 7.82 nm, while for PPYₛᵥₚ48h, 5.39 nm. Thus, the pore volume may be controlled based on the reaction time.

The maximum BET surface area of nanoporous PPYₛᵥₚ polymers was observed as 51.34 cm2/g for PPYₛᵥₚ2h; and the surface area decreased as the reaction time increased, e.g., as can be seen from Table 1 above, the minimum value was observed for PPYₛᵥₚ6h. In addition, as can be seen from Table 2 below, hydrogen storage capacity of nanoporous PPYₛᵥₚ was comparable with that of the existing various high surface area polymer materials used for hydrogen storage. However, these materials were those prepared by complex chemical reactions where the reagents were expensive and strict experimentation and reaction optimizations were needed. For example, in the existing process of hyper-crosslinking polypyrroles through complex chemical reactions to synthesize nanoporous polypyrroles, the maximum hydrogen adsorbing capacity was reported to provide 1.6 wt % at 77 K and 0.4 MPa. Further, in the case of the preparation by electrochemical polymerization method, the maximum BET surface area was 37.1 m2/g, and the product provided a wide range of pore size distribution with the diameter of up to 100 nm in macro-pores.

TABLE 2

| | BET | Hydrogen | | |
|---|---|---|---|---|
| | surface | adsorbing | | |
| | area | capacity (wt/%) | Pressure | |
| sample | [m²/g] | at 77 K | [MPa] | Reference |
| Hypercrosslinked | 632 | 2.2 | 3 | a) |
| polyaniline | | | | |
| Nanoporous | 762 | 2.2 | 6 | b) |
| PT4AC | | | | |
| Hypercrosslinked | 720 | 1.6 | 0.4 | c) |
| polypyrrole | | | | |
| Nanoporous Co- | 423 | 1.24 | 8 | d) |
| PBS-350C | | | | |
| Micro-porous | 1031 | 2.78 | 6 | e) |
| polyphenylene, | | | | |
| POP1 | | | | |
| Micro-porous | 1033 | 2.35 | 6 | f) |
| polyphenylene, | | | | |
| POP4 | | | | |
| PPYₛᵥₚ2 h | 51.34 | 2.2 | 9 | The inventive |
| | | | | sample |
| PPYₛᵥₚ6 h | 40.31 | 1.9 | 8 | The inventive |
| | | | | sample |
| PPYₛᵥₚ24 h | 40.36 | 1.44 | 8 | The inventive |
| | | | | sample |
| PPYₛᵥₚ48 h | 40.99 | 0.71 | 8 | The inventive |
| | | | | sample |

a) “Journal of Materials Chemistry” 2007, 17: 4989-4997 by J. Germain, J. M. J. Frechet, F. Svec.
b) “Macromolecules” 2009, 42: 1554-1559 by S. Yuan, S. Kirklin, B. Dorney, D. J. Liu, L. Yu.
c) “Chemical Communications” 2009, 1526-1528 by J. Germain, J. M. J. Frechet, F. Svec.
d) “Macromolecular Rapid Communications” 2012, 33: 407-413 by S. Yuan, D. White, A. Mason, B. Reprogle, M. S. Ferrandon, L. Yu, D. J. Liu.
e) “Chemical Communications” 2010, 46: 4547-4549 by S. Yuan, B. Dorney, D. White, S. Kirklin, P. Zapol, L. Yu, D. J. Liu.
f) “Chemical Communications” 2010, 46: 4547-4549 by S. Yuan, B. Dorney, D. White, S. Kirklin, P. Zapol, L. Yu, D. J. Liu.

Meanwhile, the hydrogen adsorbing capacity of PPYₛᵥₚ was determined under high pressure. The results are summarized in Table 1 above. The hydrogen adsorption was measured at 77 K, and PPYₛᵥₚ shows various reversible storage capacity having the values of 0.71 to 2.2 wt % through hydrogen adsorption mechanism based on physical adsorption. The adsorbing capacity is viewed as dependent on the pore volume and the sponge-like structure. As can be seen from Table 1 above, PPYₛᵥₚ2h shows the highest value of hydrogen adsorbing capacity as 2.2 wt %. Considering that the materials prepared in accordance with the embodiments of the present invention have small surface areas, such hydrogen adsorbing capacity values were relatively high, which was comparable with the values of commercial nanoporous polymers having high surface areas indicated in Table 2 above. Likewise, when the reaction time increased, much more oxidant particles were consumed, and the inner pockets and the pore volumes were reduced, and therefore the hydrogen storage capacity become decreased (e.g., 1.9 wt % for PPYₛᵥₚ6h). Similarly, in the case of PPYₛᵥₚ24h and PPYₛᵥₚ48h, when the reaction time increased, the sponge-like structures were reduced, and the pore volume, and the inner pockets and pores were reduced, and therefore the hydrogen storage capacity becomes decreased (1.44 wt % for PPYₛᵥₚ24h, and 0.71 wt % for PPYₛᵥₚ48h). Meanwhile, a carbon dioxide adsorbing capacity of PPYₛᵥₚ2h was 8.8 wt % and 5.72 wt % at 273 K and 298 K under 1 bar pressure, respectively.

Isoelectronic heat of adsorption was further calculated from isothermal adsorption curves at 77 K, 195 K and 273 K under 1 bar pressure. The above temperatures were those selected to minimize the uncertainty in the measurements of the isoelectronic adsorption heat, and improve the accuracy using the Clausius-Clapeyron Equation.

The average isoelectronic heat of adsorption of PPYₛᵥₚ2h was 7.51 kJ/mol. The initial adsorption heat at zero coverage was 13.67 kJ/mol. The isoelectronic heat of adsorption was decreased with the hydrogen adsorption increased, which suggests the fact that inhomogeneous surfaces for hydrogen adsorption may be present. Such isoelectronic heat of adsorption values indicate that the interactions between the hydrogen molecules, and the pore surface and the walls of the inner pockets become improved through pi-electron system, and the sponge-like structures of PPYₛᵥₚ2h polymer play an important role in storing hydrogen. It should be noted that the isoelectronic heat of adsorption of PPYₛᵥₚ2h is much higher than those reported for other porous carbons, metal-organic frameworks (MOFs), and hypercrosslinked polystyrenes. Meanwhile, the nanoporous PPYₛᵥₚ prepared in accordance with the exemplary embodiments of the present invention exhibits an excellent adsorbing capacity for other gases such as methane and carbon dioxide, and therefore may be further used in capacitors and the like.

According to the present invention, the present invention can provide a new form of nanoporous polypyrrole having a sponge-like structure where permanent mesopores are formed on the surface and inside thereof. In particular, a method for preparing a nanoporous polypyrrole according to the present invention is simple and environment-friendly, as well as can obtain a nanoporous polypyrrole having various pore diameters through the control of reaction condition. Further, the prepared nanoporous polypyrrole exhibits an eminent storage capacity of hydrogen and an excellent adsorption capacity of carbon dioxide, as well as a higher isoelectronic heat of adsorption than the most of the gas storage materials previously reported.

What is claimed is:

1. A solid state vapor phase polymerization method for nanoporous polypyrrole, comprising:
dispersing a solid state oxidant on a substrate;
exposing the substrate and the oxidant to vapor phase pyrrole monomers to perform a polymerization reaction of the pyrrole monomers, thereby preparing a solid state polypyrrole; and
cleaning and drying the solid state polypyrrole.

2. The solid state vapor phase polymerization method for nanoporous polypyrrole of claim 1, wherein the exposing to the vapor phase pyrrole monomers is carried out for 2 to 48 hours.

3. The solid state vapor phase polymerization method for nanoporous polypyrrole of claim 1, wherein the exposing to the vapor phase pyrrole monomers includes introducing a solution of liquid state pyrrole monomers into a sealed container, and evaporating the solution.

4. The solid state vapor phase polymerization method for nanoporous polypyrrole of claim 1, wherein the oxidant includes ferric chloride(FeCl₃) powder, ammonium persulfate ((NH₄)₂S₂O₈) powder, ferric sulfate (Fe₂(SO₄)₃) powder, copper perchlorate (Cu(ClO₄)₂) powder, or a mixture thereof.

5. The solid state vapor phase polymerization method for nanoporous polypyrrole of claim 1, wherein the cleaning includes primarily cleaning the solid state polypyrrole with deionized water and secondarily cleaning the solid state polypyrrole with methyl alcohol.

6. The solid state vapor phase polymerization method for nanoporous polypyrrole of claim 1, wherein the drying is carried out at a temperature of 50° C. to 160° C. under vacuum.

7. A nanoporous polypyrrole prepared by the method of claim 1.

8. The nanoporous polypyrrole of claim 7, wherein the nanoporous polypyrrole has a sponge-like structure in which mesopores having a diameter of about 1.75 nm to 9.5 nm are formed on the surface and inside thereof.

9. The nanoporous polypyrrole of claim 8, wherein the nanoporous polypyrrole, at the temperature of 77 K under a pressure of 8 MPa to 9 MPa, is capable of adsorb 0.70 wt % to 2.5 wt % of hydrogen gas thereon with reference to the weight of the nanoporous polypyrrole.
